(19) United States
(12) Patent Application Publication
(10) Pub. No.: US 2026/0064254 A1
(43) Pub. Date: Mar. 5, 2026

(54) DIGITAL MAP LAYER ARCHITECTURE

(71) Applicant: Xsensor Technology Corporation, Calgary (CA)

(72) Inventors: Ian Main, Calgary (CA); Shale Monds, Calgary (CA); Taryn Kathryn Presseau, Calgary (CA)

(21) Appl. No.: 18/818,561

(22) Filed: Aug. 28, 2024

(51) Int. Cl. G06F 3/04845; G01C 21/36

(52) U.S. Cl. CPC G06F 3/04845; G01C 21/367; G01C 21/3673; G06F 2203/04806

(57) ABSTRACT

A computing server may cause to display, at a client device, a graphical user interface that comprises a map panel and a data entry panel. The map panel comprises a multi-layer map. The multi-layer map comprises a base layer corresponding to a tile map retrieved from a third-party map data provider and additional layers that overlay data from the computer server to the base layer. The computing server may receive a user input interacting with the graphical user interface. The computing server may determine, based on the user input, a view area of the base layer, the view area corresponding to a geographical area and a zoom level on the base layer. A computing server may determine, based on the view area, coordinate clusters that fall within the view area, the coordinate clusters representing a predetermined set of locations that are to be highlighted in the map panel.

### TECHNICAL FIELD

The present disclosure generally relates to a graphical user interface that includes a multi-layer map that applies filters to a map and a data entry panel to also apply filters to a set of data entries in a list view.

### BACKGROUND

Traditional Geographic Information System (GIS) interfaces commonly utilize a map layer as the foundational element for displaying GIS data. Typically, interfaces incorporate a tile map base layer and a data entry panel to present a list view of accessible data entries. Conventional GIS interfaces lack the functionality to allow for a user to apply multiple filters to tailor the map view of the data entries. Such interfaces only allow for users to apply a limited set of filters to apply to the map view of the data entries.

In conventional systems, users select data entries from a predefined list in display of the data entry panel, the selected data entries are in view of the map and the data entry panel. Users may not select a data entry from the data entry panel independently of a data entry selected in the map view. This approach restricts the user's ability to interactively manage and visualize complex datasets, as there is no provision for applying various layers or filters independently to refine data visualization. As a result, such interfaces have limited functionality and applicability when handling intricate or multi-dimensional GIS data, thereby limiting a users' ability to perform comprehensive analyses and to gain insights from the data efficiently.

### SUMMARY

In some embodiments, the disclosure described herein relate to a computer-implemented method, including: causing to display, by a computing server at a client device, a graphical user interface that includes a map panel and a data entry panel, the map panel includes a multi-layer map, wherein the multi-layer map includes a base layer corresponding to a tile map retrieved from a third-party map data provider and additional layers that overlay data from the computer server to the base layer; receiving a user input interacting with the graphical user interface; determining, based on the user input, a view area of the base layer, the view area corresponding to a geographical area and a zoom level on the base layer; determining, based on the view area, coordinate clusters that fall within the view area, the coordinate clusters representing a predetermined set of locations that are to be highlighted in the map panel; causing the coordinate clusters to be displayed as line features at a second layer of the multi-layer map; receiving, from the user device, a toggle selection of two or more metadata tags including a first metadata tag and a second metadata tag; causing to display, at a third layer of the multi-layer map, a first set of data entry nodes whose corresponding data entries are assigned with the first metadata tag and a second set of data entry nodes whose corresponding data entries are assigned with the second metadata tag, wherein the display of the two sets of data entry nodes is togglable; determining, based on the view area, a third set of data entries that are assigned with a third metadata tag; and causing to display, at the data entry panel of the graphical user interface, a list view of the third set of data entries, wherein a data entry node in the third set is displayable at the map panel while the first and second sets of data entry nodes continue to display at the map panel.

In some embodiments, the disclosure described herein relate to a computer-implemented method, wherein the data retrieved from the third-party map data provider includes geospatial data, satellite imagery, street maps, data about specific points of interest, demographic data, and real-time data.

In some embodiments, the disclosure described herein relate to a computer-implemented method, wherein the metadata tag is a label to describe various attributes of properties of a specific point of interest.

In some embodiments, the disclosure described herein relate to a data entry, wherein a data entry is map data or descriptive data of a point of interest. A data entry may be geographical data (i.e., locational coordinates) describing a restaurant, retail store, or hotel. A data entry may also be a descriptive datapoint (e.g., reviews, pricing, atmosphere, etc.).

In some embodiments, the disclosure described herein relate to a computer-implemented method, wherein the metadata tag labels a point of interest for hotels, shops, attractions, pre-determined streets, luxurious points of interest, ease of commutability, or access to public-transportation.

In some embodiments, the disclosure described herein relate to a computer-implemented method, wherein determining the predetermined set of locations includes: extracting a set of locations of interest from third-party databases of travel aggregators and booking sites, social media platforms, tourism guides and magazines; and verifying a set of locations of interest from map and navigation databases.

In some embodiments, the disclosure described herein relate to a computer-implemented method, wherein the togglable set of data entries allows users to switch between different sets of data inputs within a single interface.

### BRIEF DESCRIPTION OF THE DRAWINGS

FIG. 1 is a block diagram illustrating an example system environment, in accordance with some embodiments.

FIG. 2 includes block diagrams illustrating various components of an example computing server, in accordance with some embodiments.

FIG. 3 is a block diagram illustrating an example map application that includes a map panel and a data entry panel, in accordance with some embodiment.

FIG. 4 is a flowchart that depicts an example process for a multi-layer data generation engine, in accordance with some embodiments.

FIG. 5 is an example graphical user interface (GUI) of a multi-layer map provided by a computing server, in accordance with some embodiments.

FIG. 6 is an example graphical user interface (GUI) of a data-entry panel provided by a computing server, in accordance with some embodiments.

FIG. 7 is an example graphical user interface (GUI) of a generated itinerary provided by a computing server, in accordance with some embodiments.

FIG. 8 is a flowchart that depicts interactions between the data entry panel and the multi-layer map, in accordance with some embodiments.

FIG. 9 is a flowchart that depicts interactions between the data entry panel and the multi-layer map, in accordance with some embodiments.

FIG. 10 is a block diagram illustrating a machine learning model, in accordance with some embodiments.

FIG. 11 is a block diagram illustrating components of an example computing machine, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed embodiments herein relate to a graphical user interface for a multi-layer map and a data entry panel. The disclosed GUI allow for a user to apply at least a filter on the multi-layer map and the data entry panel. The multi-layer map and the data entry panel may allow for a user to apply filters to data entries independently of another. The disclosed GUI allows for a user to apply at least a filter for display to the multi-layer map. The disclosed embodiment causes to display a multi-layer map according to the selected filters, wherein a layer indicates a filter applied to received data entries. The multi-layer map includes a tile map with a coordinate cluster, representing a cluster of coordinates of interest, in persistent view of the multi-layer map. The data entry panel may display data entries for a selected filter applied to the multi-layer map, or the data entry panel may display data entries for a filter selected by a user.

### Example System Environment

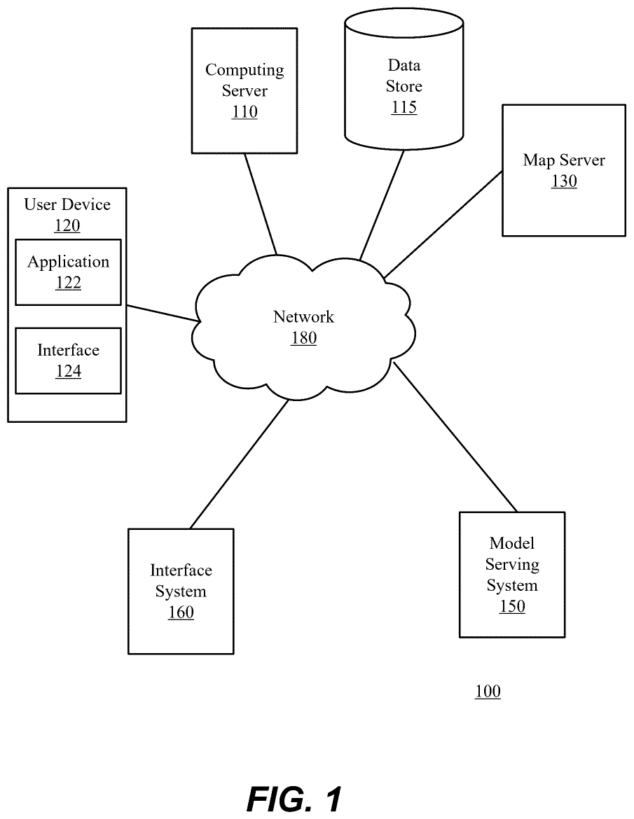

Referring now to Figure (FIG. 1, shown is a block diagram illustrating an embodiment of an example system environment 100, in accordance with some embodiments. By way of example, the system environment 100 includes a computer server 110, a data store 115, a user device 120, a map server 130, a model serving system 150, and an interface system 160. The entities and components in the system environment 100 may communicate with each other through the network 180. In various embodiments, the system environment 100 may include fewer or additional components. The system environment 100 also may include different components. Also, while each of the components in the system environment 100 is described in a singular form, the system environment 100 may include one or more of each of the components. For example, there may be multiple user devices 120 that are associated with various users. Likewise, there can be more than one model serving system 150 and more than one interface system 160, etc. For simplicity, multiple instances of a type of entity or component in the system environment 100 may be referred to in a singular form even though it may include one or more entities or components.

A computing server 110 may include one or more computing devices that perform various tasks related to providing a data rich and augmented map to end users, including tasks such as applying filters on data entries and providing related information of data entries. Additional tasks may include identifying coordinate clusters representing a predetermined set of locations and providing an interactive view of the data entries to represent a predetermined set of locations. The computing server 110 causes to display a graphical user interface that includes a map panel and a data entry panel. Both the map panel and data entry panel may display data entries and related information of the entries in specific ways that are inter-related to provide map illustration that graphically illustrates data entries in a visually organized way relative to the map. The computing server 110 receives user input interacting with the graphical user interface, which may include selection on the map panel and/or the data entry panel. The computing server 110 causes to determine coordinate clusters that fall within a view area of the graphical user interface. The computing server 110 applies filters on the data entries and represents the data entries graphically and/or geographically relative to a map.

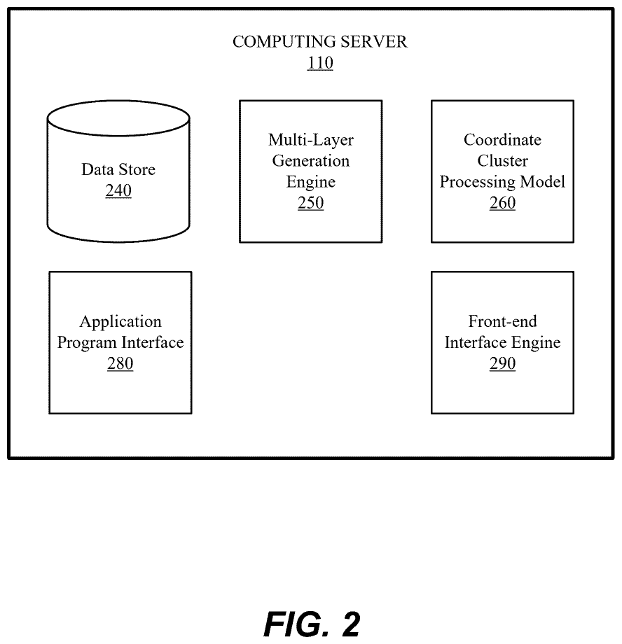

The computing server 110 may take the form of a combination of hardware and software. Some or all of the components of a computing machine of the computing server 110 is illustrated in FIG. 2. The computing server 110 may take different forms. In some embodiments, the computing server 110 may be a server computer that executes code instructions to perform various processes described herein. In other cases, the computing server 110 may be a pool of computing devices that may be located at the same geographical location (e.g., a server room) or be distributed geographically (e.g., clouding computing, distributed computing, or in a virtual server network). The computing server 110 may also include one or more virtualization instances such as a container, a virtual machine, a virtual private server, a virtual kernel, or another suitable virtualization instance. The computing server 110 may perform various tasks related to extracting and providing geographical site information as a form of cloud-based software, such as software as a service (SaaS), through the network 180.

The data store 115 includes one or more storage units such as memory that takes the form of non-transitory and non-volatile computer storage medium to store various data that obtained by the computing server 110 or by various users of the computing server 110. For example, the data stored in data store 115 may include data entries and a description of the data entry, organized by data entry type. The computer-readable medium is a medium that does not include a transitory medium such as a propagating signal or a carrier wave. The data store 115 may take various forms. In one embodiment, the data store 115 communicates with other components by the network 180. This type of data store 115 may be referred to as a cloud storage server. Example cloud storage service providers may include AMAZON AWS, DROPBOX, RACKSPACE CLOUD FILES, AZURE BLOB STORAGE, GOOGLE CLOUD STORAGE, etc. In another embodiment, instead of a cloud storage server, the data store 115 is a storage device that is controlled and connected to the computing server 110. For example, the data store 115 may take the form of memory (e.g., hard drives, flash memory, discs, ROMs, etc.) used by the computing server 110 such as storage devices in a storage server room that is operated by the computing server 110.

A user device 120 may be a computing device that can transmit and receive data via the network 180. A user device 120 may be any computing device. Examples of such user devices 120 include personal computers (PC), desktop computers, laptop computers, tablets (e.g., IPADs), smartphones, wearable electronic devices such as smartwatches, application-specific devices designed to be specifically used with the computing server 110, or any other suitable electronic devices.

Users of the user device 120 may include, but not limited to, end users of a map application that is provided by the computing server 110. A user also may be referred to as a client or an end user of the computing server 110. The user device 120 may be referred to as a client device or an end user device. A user may use the user device 120 to retrieve information related to data entries, applying filters to data entries, and accessing and viewing digital maps that display data entries and a description related to the data entry. In some embodiments, a user device 120 includes one or more applications 122 and user interfaces 114 that may display visual elements of the applications 122.

An application 122 may be any suitable software application that operates at the user device 120. A user device 120 may include various applications 122 such as a software application provided by the computing server 110. The application 122 may provide a digital map that displays various data entry information on or next to the map, such as by overlaying representations of data entries on a map panel and putting the same or another list of data entries in a data entry panel next to the map panel.

An application 122 may be of different types. In one case, an application 122 may be a web application that runs on JavaScript or other alternatives, such as TypeScript, etc. In the case of a web application, the application 122 cooperates with a web browser to render a front-end interface 124. In another case, an application 122 may be a mobile application. For example, the mobile application may run on Swift for iOS and other APPLE operating systems or on JAVA or another suitable language for ANDROID systems. In yet another case, an application 122 may be a software program that operates on a desktop computer that runs on an operating system such as LINUX, MICROSOFT WINDOWS, MAC OS, or CHROME OS.

An interface 124 may be a suitable interface for a user device 120 to interact with computing server 110. The interface 124 may include various visualizations and graphical elements to display information for users and may also include input fields to accept inputs from users. A user may communicate to the application 122 and the computing server 110 through the interface 124. The interface 124 may take different forms. In one embodiment, the interface 124 may be a web browser such as CHROME, FIREFOX, SAFARI, INTERNET EXPLORER, EDGE, etc. and the application 122 may be a web application that is run by the web browser. In another application, the interface 124 is part of the application 122. For example, the interface 124 may be the front-end component of a mobile application or a desktop application. The interface 124 also may be referred to as a graphical user interface (GUI) which includes graphical elements to display a digital map and data entries.

A map server 130 may be a third party server that provides a geographical map layer using a geographic database such as OpenStreetMap (OSM) or any suitable mapping tools. The map server 130 may provide a tile map to represent various data points spatially, such as a city's layout, land use, population density, or weather patterns. In one or more embodiments, the data retrieved from the third party map data provider may include geospatial data, satellite imagery, street maps, data about the received set of data entries, demographic data, and real-time data. The map server 130 may provide an application programming interface (API) for the computing server 110 to retrieve map data to create a map layer in the application provided by the computing server 110. For example, based on a selection of location and zoom level from an end user, the computing server 110 may generate one or more API calls to retrieve geographic data from the map server 130 to render the map layer. The map server 130 may provide digital map layer with the capability of switching to a street views.

A map server 130 may be any suitable digital map service provider that provides digital maps that provide geographic data, such as geospatial data, of streets and associated data. Also, geospatial data here is not limited to urban streets. Digital maps can also include images of rural areas, such as fields, parks, public transportation points of entry or other lands that may or may include identifiable alleys or streets. Various common digital map servers may provide street views, such as GOOGLE MAP, MAPILLARY, OPENSTREETCAM, APPLE MAP, etc. In some embodiments, the computing server 110 may also be part of the map server 130. In other embodiments, the computing server 110 and the map server 130 are operated by different entities. The computing server 110 may rely on the API service provided by the map server 130 to render a map layer and overlay the custom data of the computing server 110 with the map server 130 to generate a custom map.

A model serving system 150 may receive requests from the computing server 110 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. For example, the computing server 110 may communicate with the model serving system 150 to ask a language model to generate a narrative or description of a data entry stored by the computing server 110. In some embodiments, a data entry may be associated with the geographical site (e.g., point of interest). The computing server 110 may request the model serving system 150 to generate the description of the site and also photos of the site. In some embodiments, the computing server 110 may also receive a query (e.g., prompt, communication, message) from an end user using the map application provided by the computing server 110. The computing server 110 may generate a response to the query by using the language model provided by the model serving system 150. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 may receive a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens is arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has a significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the model serving system 150. In some embodiments, the LLM may also be fine-tuned by the model serving system 150 or the computing server 110. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While an LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the computing server 110 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the computing server 110 is connected to an interface system 160. The interface system 160 receives external data from the computing server 110 builds a structured index over the external data using, for example, another machine-learned language model or heuristics. The interface system 160 receives one or more queries from the computing server 110 on the external data. The interface system 160 constructs one or more prompts for input to the model serving system 150. A prompt may include the query of the user and context obtained from related data entries. In one instance, the context in the prompt includes portions of the structured indices as contextual information for the query. The interface system 160 obtains one or more responses from the model serving system 160 and synthesizes a response to the query on the external data. While the computing server 110 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data sources.

The network 180 provides connections to the components of the system environment 100 through one or more sub-networks, which may include any combination of the local area and/or wide area networks, using both wired and/or wireless communication systems. In one embodiment, a network 180 uses standard communications technologies and/or protocols. For example, a network 180 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 180 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 180 may be represented using any suitable format, such as hypertext markup language (HTML), extensible markup language (XML), JavaScript object notation (JSON), structured query language (SQL). In some embodiments, all or some of the communication links of a network 180 may be encrypted using any suitable technique or techniques such as secure sockets layer (SSL), transport layer security (TLS), virtual private networks (VPNs), Internet Protocol security (IPsec), etc. The network 180 also includes links and packet switching networks such as the Internet.

### Example Computing Server Components

FIG. 2 is a block diagram illustrating various components of an example computing server 110, in accordance with some embodiments. In various embodiments, the computing server 110 may include fewer or additional components. The computing server 110 also may include different components. The functions of various components in the computing server 110 may be distributed in a different manner than described below. Moreover, while each of the components in FIG. 2 may be described in a singular form, the components may be present in plurality. Further, the components of the computing server 110 may be embodied as modules that include software (e.g., program code including instructions) that is stored on an electronic medium (e.g., memory) and executable by a processing system (e.g., one or more general processors). The components also could be embodied in hardware, e.g., field-programmable gate arrays (FPGAs) and/or application-specific integrated circuits (ASICs), that may include circuits alone or circuits in combination with firmware and/or software.

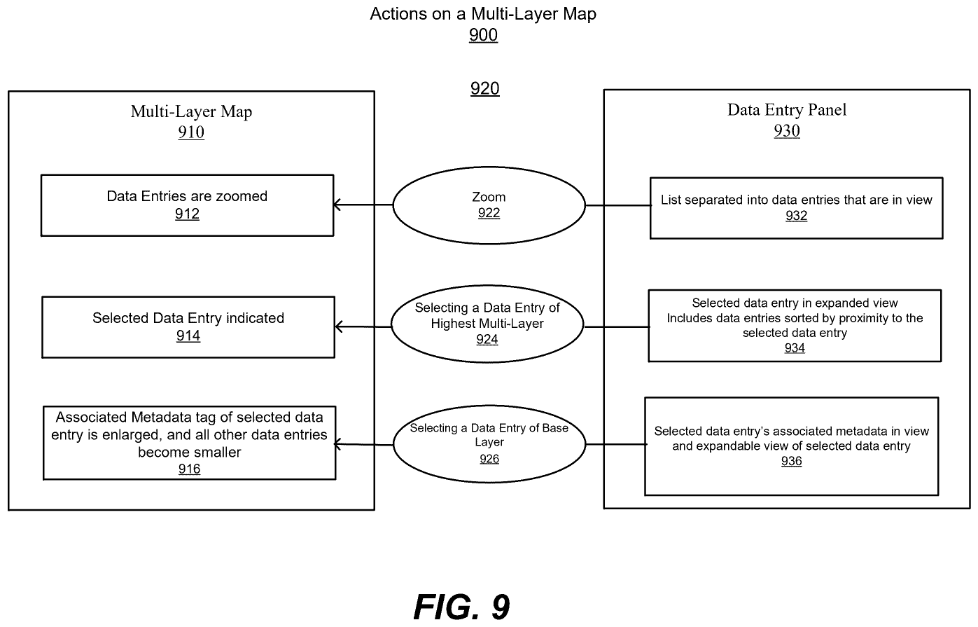

A computing server 110 includes various components that perform tasks related to filtering and accessing data entries related to mapping. In some embodiments, the computing server 110 may include a data store 240, a multi-layer generation engine 250, a coordinate cluster processing model 260, an application program interface (API) 280, and a front-end interface engine 290. Each engine and component in the computing server 110 may include software algorithms that work with hardware as described in FIG. 9.

A data store 240 may be a data store of the computing server 110 that is used to store data generated by the computing server 110, various location and map data such as GIS latitude and longitude coordinates, a description of the data entries, and at least a metadata tag associated with the data entry. Other data may include a description of the data entries generated by the model serving system 160. A data entry may be data for a point of interest, restaurant, retail stores, hotels, reviews, pricing, etc. The data store 240 includes non-transitory and non-volatile memory and may be an example of data store 115. The data store 240 may include unstructured data, semi-structured data, and structured data. Unstructured data may include raw data, emails, documents, and files. Semi-structured data may include various artificial intelligence models, machine learning models, and probability processing models, photos, user data and analytics. Structured data may include mapping data, location data, user input data, geospatial information, and other data that are converted to structured data by the data mining engine 220. Various suitable data structures such as Structured Query Language (SQL), other relational database structures, and/or NoSQL that uses key-value pairs, wide columns, graphs, inversed indices, tabular stores, or resource description framework (RDF) may be used in the data store 240.

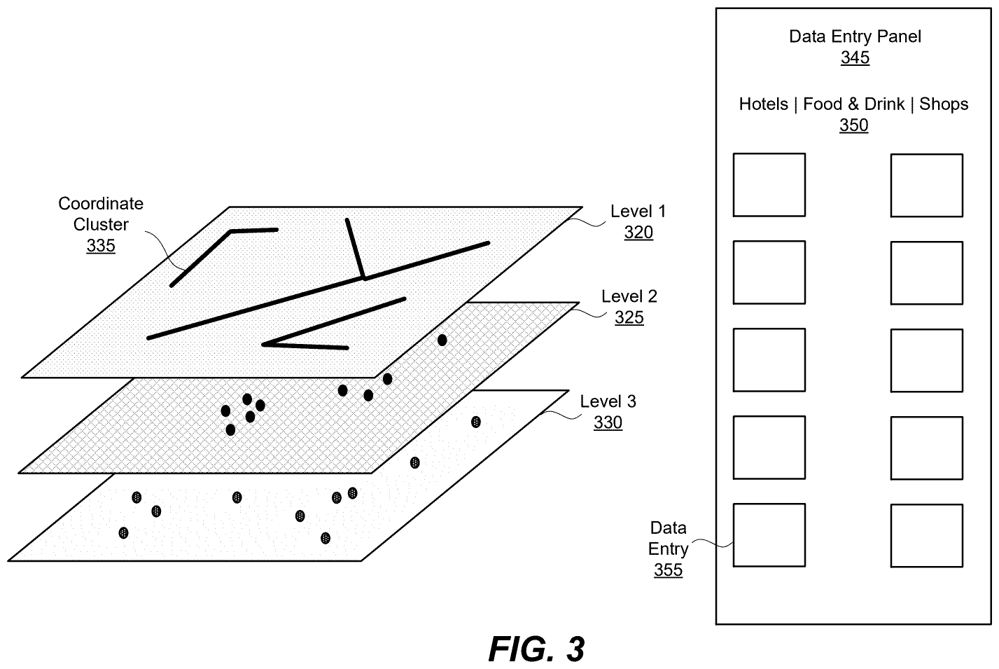

A multi-layer data generation engine 250 causes to display, at least a multi-layer map. A data entry may include locational data of the data entry, a description of the data entry, attribute data of the entry and metadata. The multi-layer data generation engine 250 may apply a data entry tag on the data entries to filter the data entries. The metadata tag may filter by points of interest, entity type, geographical location type, etc. As an example, a metadata tag may be for hotels, attractions, luxury, or food and drink shops data entries. The luxury metadata tag may describe luxurious hotels, food and drink shops, or other attractions. The multi-layer map may include a tile map received from the data store 240 to display the locational data of the data entries. The multi-layer map is further described in FIG. 3. The multi-layer data generation engine 250 may also cause to display a data entry panel to describe data associated with the data entries. The multi-layer data generation engine 250 receives a user input interacting with the graphical user interface UI. The multi-layer data generation engine 250 determines, based on the view area, coordinate clusters determined by a coordinate cluster processing model 260 that fall within the view area. The multi-layer data generation engine 250 causes to display the coordinate clusters as a line feature as a second layer of the multi-layer map. The multi-layer data generation engine 250 causes to display, at least a third layer of the multi-layer map for a set of data entries associated with a metadata tag. For example, the multi-layer data generation engine 250 causes to display associated data entries with the metadata tag for luxury. Further, the multi-layer data generation engine 250 causes to display, at a data entry panel, a list view of the data entries associated with a metadata tag. The list view includes the description of the data entries.

The coordinate cluster processing model 260 determines areas that are defined by a collection of geographical coordinates. The collection of coordinates may refer to as a coordinate cluster. The coordinate clusters represents a predetermined set of locations that can be highlighted in the map panel. A coordinate cluster processing model 260 causes to produce a cluster of data entries received from the data store 240. A coordinate cluster represent a pre-determined set of locations on view in a tile map to indicate a cluster of location of interests to a user. A coordinate cluster may represent a location of interest for a user (e.g., popular areas with highly-rated restaurants, popular areas to view landmarks, and walkable and safe areas). The coordinate cluster processing model 260 may receive the predetermined set of locations from a data store 240 of a third-party database. The coordinate cluster may be viewable as a solid line within the view area of the base level of the multi-layer map.

A coordinate cluster may be generated by extracting a set of locations of interests from third party-party databases of travel aggregators, booking sites, social media platforms, tourism guides and magazines. A coordinate cluster may be verified as a set of predetermined locations of interest, clusters, from map and navigation databases. A coordinate cluster may also be created manually based on known areas of interests of a city or an urban area. In some embodiments, a coordinate cluster may be collected based on the end-user data of the users of the application 122. For example, when an end user travel to an area, upon the authorization of the user, the computing server 110 may track the locations of the user. The computing server 110 may aggregate a number of users' locations and determine favorite travel locations of a particular area. The computing server 110 may create a coordinate cluster that collects a list of coordinates associated to the area.

An application program interface (API) 280 of the computing server 110 exchanges data with various entities through computer code and programming language so that the exchange of information can be automated and conducted in a much fast manner. The API 280 may be for outbound information. For outbound information, the computing server 110 may prompt third-party large language models as input to generate a description associated with the data entry. The API 280 may be in compliance with any common API standards such as Representational State Transfer (REST), query-based API, Webhooks, etc. The data transferred through the API 280 may be in formats such as JavaScript Object Notation (JSON) and Extensible Markup Language (XML).

A front-end interface engine 290 may provide an interface to transmit and display a multi-layer map and a data entry panel. The front-end interface engine 290 may be in the form of a graphical user interface (GUI) to display the digital map and allow users to provide inputs via the GUI. A user may input manual actions and feedbacks through one or more icons in the GUI. For example, a user may select a metadata tag from a togglable set of metadata tags to cause to display an additional layer of the multi-layer map. The front-end interface engine 290 may take different forms. In one embodiment, the front-end interface engine 290 may control an application 122 that is installed in a user device 120. For example, the application 122 may be a cloud-based SaaS or a software application that can be downloaded in an application store (e.g., APPLE APP STORE, ANDROID STORE). The front-end interface engine 290 may be a front-end software application that can be installed, run, and/or displayed at a user device 120 for users. The front-end interface engine 290 also may take the form of a webpage interface of the computing server 110 to allow users to access data and results through web browsers.

### Example Multi-Layer Map and Data Entry Panel

FIG. 3 is a block diagram illustrating an example map application 122 that includes a map panel and a data entry panel, in accordance with some embodiment. The map panel includes a multi-layer map that renders map data from a map server 130 in one layer and overlay filtered data from the computing server 110 in other layers. The entries in data entry panel 345 may be generated by the multi-layer data generation engine 250, in accordance with some embodiments. A multi-layer data generation engine 250 generates a data entry panel 345 and a multi-layer map.

The multi-layer data generation engine 250 determines, based on the user input, a view area of the base layer. The view area may correspond to a geographical area and a zoom level on the base layer, level 1 320. The user input may be a coordinate for a location of interest or a city as a view area of the base layer. The view area includes a layer that displays a coordinate cluster 335 within the view area of the base layer. The user may select a data entry on the base layer. The multi-layer data generation engine 250 may generate a filter for a metadata tag associated with the selected data entry on the base layer. The multi-layer data generation engine 250 may cause to display additional data entries associated with the selected metadata tag. The coordinate cluster 335 represents a predetermined set of data entries in view of the base layer. As an example, the coordinate cluster 335 may represent a series of streets of interest for a user visiting a location within the view area of the base layer. In some embodiments, the coordinate cluster is persistently presented in the map regardless of the zoom level of the base layer. In some embodiments, the coordinate cluster may be toggled on and off by the end user. When the coordinate cluster is toggled on, the display of which may be unaffected by other selections from the user, such as the selection of a data entry, a filter, or a category of locations that are displayed in another layer of the map panel. By displaying a persistent coordinate cluster, other data entries can be represented in the map geographically relative to the coordinate cluster to provide a clear visual explanation of sites of interest relative to popular areas that are represented by the coordinate cluster.

In some embodiments, the multi-layer data generation engine 250 may apply, based on the user input, a metadata tag to generate an additional level of the multi-layer map. As an example, the multi-layer map may cause the view of the data entries associated with a metadata tag for hotels as level 2 325 of the multi-layer map. The multi-layer data generation engine 250 receives user input of a metadata tag (e.g. hotels), which causes to display data entries labeled with the corresponding metadata tag. The multi-layer data generation engine 250 causes to display a graphical representation (e.g., a shaded dot icon) to represent the data entry associated with the metadata tag. The multi-layer data generation engine 250 applies, based on a second user input, an additional level, level 3 330, of the multi-layer map, to cause to display a data entry indicated by a striped dot icon. The multi-layer map may select data entries dependently of previously selected metadata tags. As an example, the metadata tag for luxury items may cause the data generation engine to filter the data entries from the previously selected level 2 325, for luxury hotels as a data point of interest for the user.

In some embodiments, the data entry panel 345 may present a list view of the data entries associated with a metadata tag. The data entry panel 345 includes an interface to select from the set of metadata tags 350. In FIG. 3, the corresponding metadata tags 350 for the data entry panel 345 are hotels, food and drink, and shops. A user may select a metadata tag to present in list view for the data entry 355. A data entry 355 includes a description of the data entry. In one embodiment, the description may be generated by the model serving system 150. As an example, for a data entry of a hotel within view of the base area, the model serving system 150 may include the data entry and a prompt to “Generate an engaging description of the received data entry”. The computing server 110 may receive from the model serving system 150 a description of the hotel as “A charming, eclectic hotel in the heart of Paris, France with a 4-star rating”. The selected data entry 355 is persistently in view of level 1 320, regardless of the zoom level.

In some embodiments, the multi-layer map interface is a separate interface from the data entry panel 345 and may work both independently and dependently from a user interaction of the data entry panel 345 and the multi-layer map interface. For instance, a user may select a data point associated with level 3 330 of the multi-layer map to cause to display the corresponding data entry 355 associated with the selected data point. The multi-layer map interface and the data entry panel 345 may work independently by user interaction. For example, where level 3 330 represents a set of data entries for shops, a user may then select the metadata tag for shops to cause a list view of the data entries. The user may then select a data entry 355 which may then be highlighted in the corresponding map view in level 3 330 of the multi-layer map interface.

### Example Process for a Multi-Layer Data Generation Engine

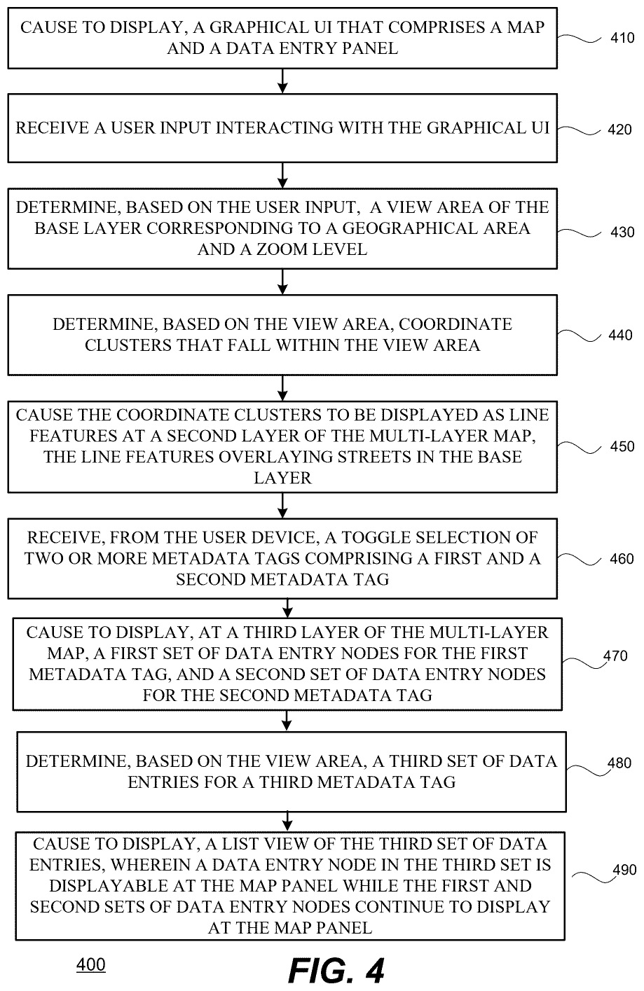

FIG. 4 is a flowchart that depicts an example process 400 for a multi-layer data generation engine, in accordance with some embodiments. The process 400 may be implemented by a computer, which may be a single operation unit in a conventional sense (e.g., a single personal computer) or may be a set of distributed computing devices that cooperate to execute a set of instructions (e.g., a virtual machine, a distributed computing system, Cloud computing, etc.). In one case, the computer may be a computing server 110 that may include memory and a processor (e.g., one or more processors). The memory may store computer code that includes instructions. The instructions, when executed by the processor, cause the processor to perform various steps described herein. Also, while the computer is described in a singular form, the computer that performs the process in FIG. 4 may include more than one computer that is associated with the computing server 110.

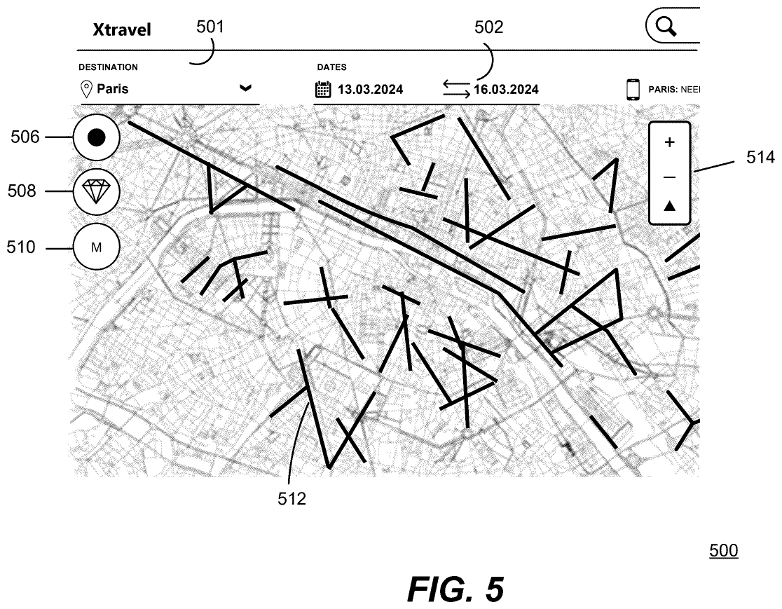

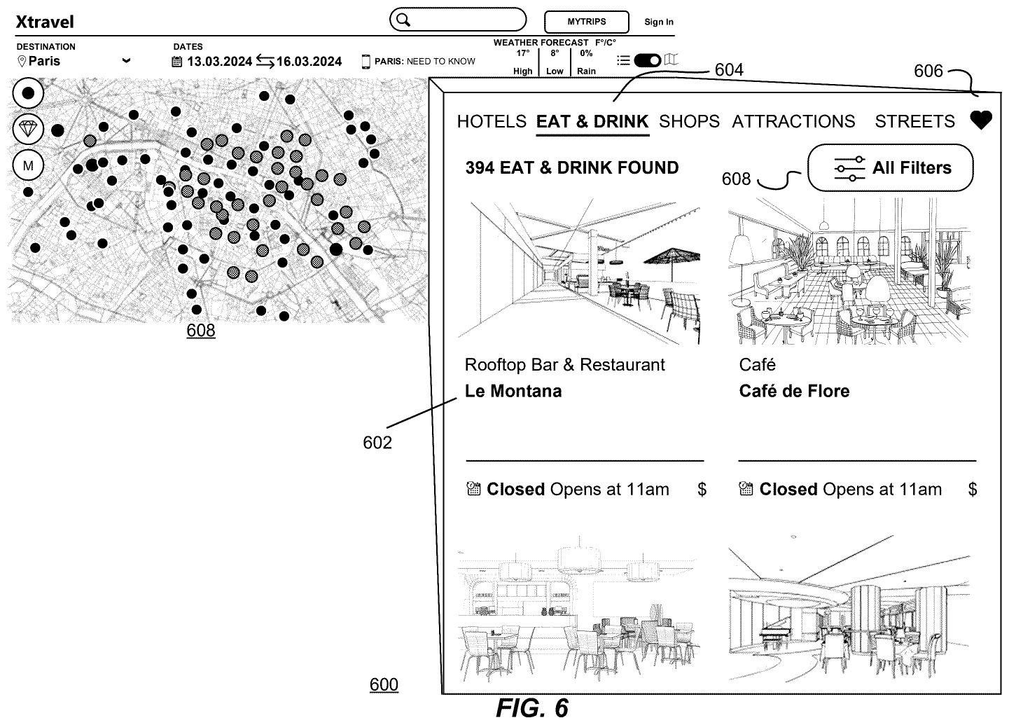

FIG. 5 and FIG. 6 are example interfaces of the multi-layer map and the data entry panel interface, in accordance with some embodiments.

In some embodiments, a computing server 110 may cause 410 to display, a graphical user interface UI that comprises a map and a data entry panel. Further detail of an example of the UI is discussed in FIG. 3. The computing server 110 receives 420 user input interacting with the graphical UI. A user may interact with the graphical UI by inputting a coordinate or location of interest for a geographical area to the user (e.g., San Francisco, CA). The computing server 110 determines 430, based on the user input, a view area of the base layer corresponding to a geographical area and a zoom level. A zoom level may be configured by a togglable interface to adjust the zoom of the view area for the geographical area.

The computing server 110 determines 440 based on the view area, coordinate clusters that fall within the view area. The coordinate cluster may be determined based on the geographical area of the base layer to represent pre-determined clusters of data entries.

The computing server 110 causes the coordinate clusters to be displayed as graphical features (e.g., line features, shading, polygons) at a second layer of the multi-layer map. The graphical features may overlay streets in the base layer 450. For example, the graphical features may be line features that overlay certain streets to represent the streets are popular or recommended streets or areas for tourists for the city. The coordinate cluster, indicated by a solid line in one of the layers, may be persistent regardless of the zoom area and regardless of user's selection of any data entries, filters, or inputs, unless the user complete toggles off the coordinate cluster. The coordinate clusters indicate clusters of coordinates in view of the zoom area to represent pre-determined streets of interest to the user.

The computing server 110 receives 460, from the user device, a selection (e.g., a toggle selection) of two or more metadata tags that includes a first and a second metadata tag. A selection of two or more metadata tags may include a metadata tag points of interest, entity type (e.g., whether the data entries represent hotels, restaurants, retail sites, etc.), geographical location type, etc. The selection of two or more metadata tags allows for a user to interact with the multi-layer map to select a metadata tag.

In some embodiments, the selection may occur in two different panels that display different sets of data entries. For example, the user may select a first set of sites associated with a first metadata tag to be geographically displayed in the map, such as by selecting data entries representing restaurants to be graphically displayed on the map. The user may additionally select a second set of sites associated with a second metadata tag to be displayed as a list of data entries in the data entry panel. For example, the user may select data entries representing retail sites to be displayed as a list of data entries. As the user selects a specific data entry in the list for additional information, the location corresponding to the data entry is automatically displayed in the map panel along with the representations of the set of sites associated with the first metadata tag that are persistently displayed in the map. This way the end user is able to determine the geographical location of the specific data entry selected in the list panel relative to first set of sites and/or relative to the coordinate cluster. In some embodiments, the user may also select to toggle on multiple sets of sites that are associated with different metadata tags to be displayed in the map panel. Each type of sites may be represented by different types of graphical elements, as shown in FIG. 6.

In response to the user selecting a metadata tag, the computing server 110 typically needs to select or rank a list of data entries that are tagged with the metadata. The filtering of the data entries may be based on various factors, such as the existing data that is currently displayed in the map panel (e.g., coordinate cluster and sites that are currently displayed), historical usage pattern of the users, view area, and other filtering criteria. For example, the map panel might have already displayed a set of coordinate clusters and a set of sites that are associated with a first metadata tag. In turn, the user may query for sites that are associated with a second metadata tag. In selecting the data entries that are to be displayed as a list in the data entry panel, the computing server 110 may determine the geographical locations of the candidate sites relative to the coordinate clusters and/or sites associated with the first metadata tag to select the data entries that are associated with the second metadata tag. In some embodiment, the user may specify one or more focal site, such as the hotel that the user is going to stay. The selection of data entries in the data entry panel may also be partially based on the geographical distances from the focal site.

The computing server 110 causes to display 470, at a third layer of the multi-layer map, a first set of data entry nodes for the first metadata tag, and a second set of data entry nodes for the second metadata tag. At a third layer of the multi-layer map, the computing server 110 displays a first set of data entry nodes for the selected first metadata tag, indicated by a UI icon. At the third layer of the multi-layer map, the computing server 110 displays a second set of data entry nodes for the selected second metadata tag, indicated by a differentiable UI icon. As an example, the third-layer of the multi-layer map may include UI icons for hotels and for restaurants within the selected view area.

The computing server 110 determines 480, based on the view area, a third set of data entries for a third metadata tag. The third metadata tag may be a previously selected metadata tag within the view area. The third metadata tag may also be another selected metadata tag within the view area. The computing server 110 determines data entries and the corresponding descriptions of the data entries for a selected metadata tag within the view area. In one embodiment, the corresponding descriptions of the data entries are generated by the model serving system 150.

The persistency of the display of graphical elements (e.g., coordinate clusters, nodes, icons) does not mean that the graphical elements will always be permanently displayed. Instead, graphically elements are persistently displayed in the map panel may refer to the display of the graphically elements will not be affected by other actions of the user (e.g., performing a search or selecting a data entry in the data entry panel) unless the user manually toggle off the persistently displayed elements. For example, the coordinate cluster, once toggled on, will be persistently displayed regardless of what searches or selections that the user performs. The searches or selections in the map panel or the data entry panel may cause additional displays of graphical elements relative to those that are already persistently displayed. For example, the popular streets that are represented by the coordinate cluster may be persistently displayed and a set of hotels may also simultaneously be persistently displayed while the user is perform a search of restaurants that may be dynamically displayed according to user selections and filtering criteria. As a result, the map panel may persistently display popular streets and a set of hotels while dynamically display locations of restaurants according to real-time selections of the users.

In some embodiments, the data entries that are persistently represented in the map panel may affect the selection and filtering of the data entries in the data entry panel. The computing server 110 may store a temporary record of data that are currently persistently displayed in the map panel. Based on the record of data that are currently persistently displayed in the map panel, the computing server 110 may select data entries that are to be displayed in the data entry panel, whether based on geographical locations to the sites that are persistently displayed or based on other affinity or association factors relative between the data entries to be selected and the sites that are persistently displayed.

The computing server 110 cause to display 490, at the data entry panel of the graphical user interface, a list view of the third set of data entries, wherein a data entry node in the third set is displayable at the map panel while the first and second sets of data entry nodes continue to display at the map panel. The list view of the third set of data entries is displayable within view of the data entry panel. The list view presents a list view of the data entries for the third metadata tag and data entry descriptions of the data entries for the third metadata tag.

### Example Graphical Representations of Multi-Layer Map

FIG. 5 is an example graphical user interface (GUI) of a multi-layer map provided by a computing server 110, in accordance with some embodiments. In various embodiments, the precise arrangement of various fields may be changed or customizable by the user. Also, one or more fields may be added, removed or modified in various embodiments of the multi-layer map 500.

The multi-layer map 500 may be a GIS map that includes various map data such as street names, street numbers, shops and restaurants, and access to public transportation spots. The multi-layer map 500 also includes coordinate clusters 512 to indicate streets of pre-determined interest to the user.

A user may indicate a location of interest 501 wherein which the computing server 110 displays a tile map view of the location of interest 501. The computing server 110 causes to generate coordinate clusters 512 for the location of interest 501. An interface to determine the zoom of the tile map 514 allows for a user to determine the zoom level within the view area of the multi-layer map for the selected location of interest 501, Paris, France. The coordinate clusters 512 remain in view independently of the view of the zoom level.

In one embodiment, a user may also indicate a date of interest 502 wherein which the computing server 110 may determine a location of interest for the user. In one embodiment, the dates of interest may determine the locations of interest and coordinate clusters 512 presented to the user. For instance, during a local event, a location of interest may be adjusted based on the user preferences. A user may indicate a strong interest to view or attend a local event, wherein which the computing server 110 determines coordinate clusters 512 surrounding the local event of interest.

The multi-layer map 500 includes an icon for metadata tags 506 on the multi-layer map 500. A user may select a metadata tag to apply to the multi-layer map.

The multi-layer map 500 includes an diamond icon to apply the metadata tag for luxury locations of interest for the user. In one embodiment, a luxury location of interest may be determined by streets near luxurious hotels, shops, and restaurants. As an example, a luxurious street may be determined by the number of 5-star hotels within a street of interest, or the number of 5-star rated restaurants on the street of interest.

The multi-layer map 500 includes a M icon to apply the metadata tag for public transportation locations of interest for the user. The public transportation locations of interest indicate a point of entry for a user. As an example, a public transportation location of interest may indicate nearby metro stops, bus stops, train stops, tram stops, ferry terminals, or bike sharing stations.

### Example Graphical Representations of Data-Entry Panels

FIG. 6 is an example graphical user interface (GUI) of a data-entry panel provided by a computing server 110, in accordance with some embodiments. In various embodiments, the precise arrangement of various fields may be changed or customizable by the user. Also, one or more fields may be added, removed or modified in various embodiments of the data entry panel 600. For simplicity and visibility of the figures, the coordinate cluster that is shown in FIG. 5 is not shown in FIG. 6. However, in some embodiments, it should be note that the coordinate cluster similar to those shown in FIG. 5 should be persistently displayed in the map panel of FIG. 6.

The data entry panel 600 includes a list view of the data entries for a user. The list view presents data entries and the corresponding data entry descriptions for the user. For a set of data entries, a user may indicate a set of filters to apply to the data entries for display in list view of the data entry panel. In some embodiment, one or more data entry descriptions and/or photos associated with the data entries may be generated through the model serving system 150 using one or more language models.

The data entry panel 600 may include a list icon interface for a user to determine a set of data entries to apply a metadata tag on the data entry panel 600. The selected metadata tag may be in view of the multi-layer map 608. For a selected metadata tag, the computing server 110 causes to display a list view of the data entries of the selected metadata tag. In FIG. 6, the computing server 110 causes to display a list view of the selected data entry 602 for a restaurant with a corresponding description of the data entry 602. In FIG. 6, a user applies a metadata tag of “Eat and Drink” for the location of interest, Paris, France. Further, a user may indicate save or favorite the data entry 602 by the heart icon 606. The heart icon 606 may indicate that the selected data entry 602 is of interest to the user. Further, in one embodiment, the heart icon may indicate that the user may plan to visit or stay at the selected data entry 602.

The computing server 110 may cause to display the corresponding data entries, indicatable by an icon interface on the multi-layer map. In FIG. 6, the fully shaded circle icon interface indicates the corresponding map view of the selected metadata tag for “eat and drink 604.

### Example Graphical Representations of Itinerary Generation

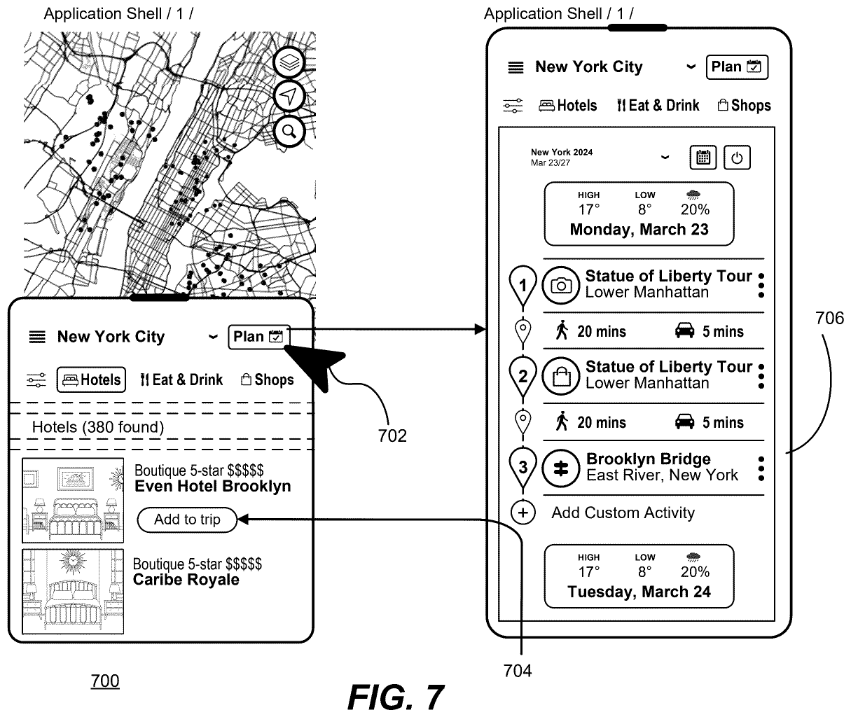

In FIG. 7, example graphical user interface (GUI) of a generated itinerary provided by a computing server 110, in accordance with some embodiments. In various embodiments, the precise arrangement of various fields may be changed or customizable by the user. Also, one or more fields may be added, removed or modified in various embodiments of the itinerary 700. For simplicity and visibility of the figures, the coordinate cluster that is shown in FIG. 5 is not shown in FIG. 7. However, in some embodiments, it should be note that the coordinate cluster similar to those shown in FIG. 5 should be persistently displayed in the map panel of FIG. 7.

In FIG. 7, the computing server 110 causes for display an itinerary for the user. An itinerary outlines the schedule of events, location of interest, destinations, activities for the user. A user may indicate in the plan icon interface 702 to cause the computing server 110 to generate an itinerary from selected data entries. In one embodiment, a user may select a location of interest to generate an itinerary.

In FIG. 7, the computing server 110 determines an itinerary with automated outlines for selected locations of interest with details including transportation and accommodations. A user may indicate by the Add to trip icon 704 to generate an itinerary from the Even Hotel in Brooklyn, NY. In FIG. 7, the computing server 110 generates details for transportation for models of transport from the Statue of Liberty Tour to the Brooklyn Bridge 706.

In one embodiment, the itinerary with the automated outline leverages AI to optimize travel routes within a specific location, tailoring user-selected preferences or favorites, as indicated by a heart icon. This AI-driven optimization not only determines the most efficient route but also sequences the points of interest (POIs) based on their type, operating hours, and estimated wait times. Additionally, the system may dynamically adjust the itinerary in real-time by tracking the user's geolocation to ensure that the travel experience remains efficient and aligned with the user's preferences throughout the journey.

### Interactions Between the Data Entry Panel and the Multi-Layer Map

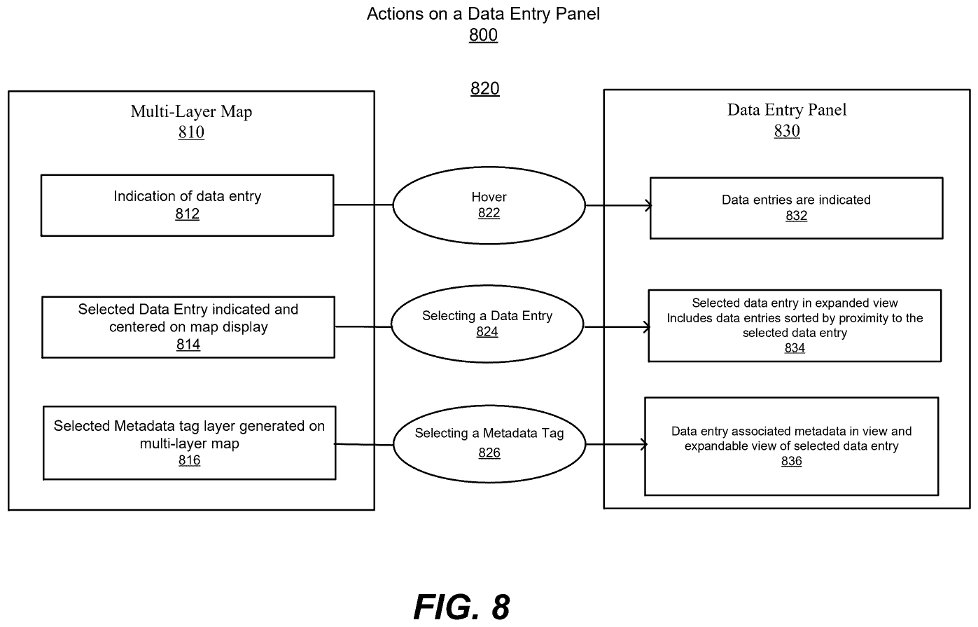

In FIG. 8, the interactions between the data entry panel and the multi-layer map are described, in accordance with some embodiments. In various embodiments, the precise arrangement of various fields may be changed or customizable by the user.

In FIG. 8, the computing server 110 describes the result of the interaction of actions a user may take on the data entry panel 800. For a set of actions 820 a user may take (e.g., hovering over a data entry 822, selecting a data entry 824, and selecting a metadata tag 826), FIG. 8 describes a set interactions between the selected action on the data entry panel 830 to the multi-layer map 810.

In one embodiment, a user may hover over a data entry 822. The interaction on the data entry panel 830 for the hovering over a data entry 822 may lead to a list separated into data entries that are in view 832. The data entries a user hovers over may be visually highlighted or bolded. In combination, the data entry that is hovered over may cause to display a highlighted or bolded indication for the icon on the multi-layer map. A user interface as a “ToolTip” box may be in view to display descriptive information of the hovered data entry.

In one embodiment, a user may select a data entry 824. The interaction on the data entry panel 830 for the selecting of a data entry 824 may lead to an expanded view of the selected data entry. Further, the data entries may be sorted by proximity to the selected data entry for display in the data entry panel 830. On the back of the data entry panel 830, the expanded card may return the user to the data entry panel 834. In combination, the selected 814 data entry may cause to display a highlighted or bolded indication for the icon on the multi-layer map. The indicated icon may also be in centered view on the multi-layer map.

In one embodiment, a user may select a metadata tag 826. The interaction on the data entry panel 830 for the selecting of a metadata tag 826 may lead to a list view of the data entries associated with the selected metadata tag in view 836. The list view of the data entries associated with the selected metadata tag in view 836 may be sorted by proximity to the center of the multi-layer map in view. The selected metadata tag may be highlighted in the data entry panel 830. In combination, the selected metadata tag may cause to generate a layer on the multi-layer map 816. The selected metadata tag layer may cause the multi-layer map to display highlighted icons.

In FIG. 9, the interactions between the data entry panel and the multi-layer map are described, in accordance with some embodiments. In various embodiments, the precise arrangement of various fields may be changed or customizable by the user.

In FIG. 9, the computing server 110 describes the result of the interaction of actions a user may take on the multi-layer map 900. For a set of actions 920 a user may take (e.g., zooming over a data entry 922, selecting a data entry of the highest multi-layer 924, and selecting a data entry of the base layer 926), FIG. 9 describes a set interactions between the selected action on the multi-layer map 910 to the data entry panel 930.

In one embodiment, a user may zoom in or out of the data entry 912 on the multi-layer map. The data entries 912 are zoomed in or out according to the user. In combination, the data entry panel is caused to display 932 data entries in list view of the data entries in current zoomed view of the multi-layer map. The list of data entries may be organized by data entries in proximity of the center of the map's current view.

In one embodiment, the selected data entry is indicated 914 on the multi-layer map. The indicated icon may also be in centered view on the multi-layer map. The interaction on the data entry panel 930 for the selecting of a data entry 924 may lead to an expanded view of the selected data entry. Further, the data entries may be sorted by proximity to the selected data entry for display in the data entry panel 934. On the back of the data entry panel 930, the expanded card may return the user to the data entry panel 934.

In one embodiment, a user may select a data entry of the base layer 926. This may cause to display the multi-layer map to generate an indicated view of the selected data entry and to generate a layer of the associated metadata tag on the multi-layer map 916. The interaction on the data entry panel 930 for the selecting of a metadata tag 926 may lead to a list view of the data entries associated with the selected metadata tag in view 936. The list view of the data entries associated with the selected metadata tag in view 936 may be sorted by proximity to the center of the multi-layer map in view. The selected metadata tag may be highlighted in the data entry panel 930.

### Example Machine Learning Model

In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, various prediction tasks performed by the computing server 110, content generation tasks performed by model serving system 150, and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to predict the data entries to be selected in the data entry panel 345, the training samples may include historical user actions related to how user may select a data entry relative to things that are persistently displayed in the map panel. The labels for each training sample may be binary or multi-class. In training a machine learning model for selecting data entries to be displayed in the data entry panel 345, the training labels may include a positive label that indicates a positive interaction of the user with respect to a data entry and a negative label that indicates a user did not take any action with respect to a displayed data entry. In some embodiments, the training labels may also be multi-class such as including ranking or review of users with respect to sites.

By way of example, the training set may include multiple past records of data entry interactions with known outcomes. Each training sample in the training set may correspond to a past and the corresponding outcome may serve as the label for the sample. A training sample may be represented as a feature vector that include multiple dimensions. Each dimension may include data of a feature, which may be a quantized value of an attribute that describes the past record. For example, in a machine learning model that is used to selection of data entries, the features in a feature vector may include metadata of the data entries, the type of data entry, opening hours and wait time of the data entry, updates in real-time of geographical locations of the user mobile device, the user historical interactions with respect to the data entries, geographical coordinates, geographical distances to another location, etc. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in selecting data entries, the objective function may correspond to the error in predicting whether the user would select a data entry. In various embodiments, the error rate may be measured as cross-entropy loss, L1 loss (e.g., the sum of absolute differences between the predicted values and the actual value), L2 loss (e.g., the sum of squared distances).

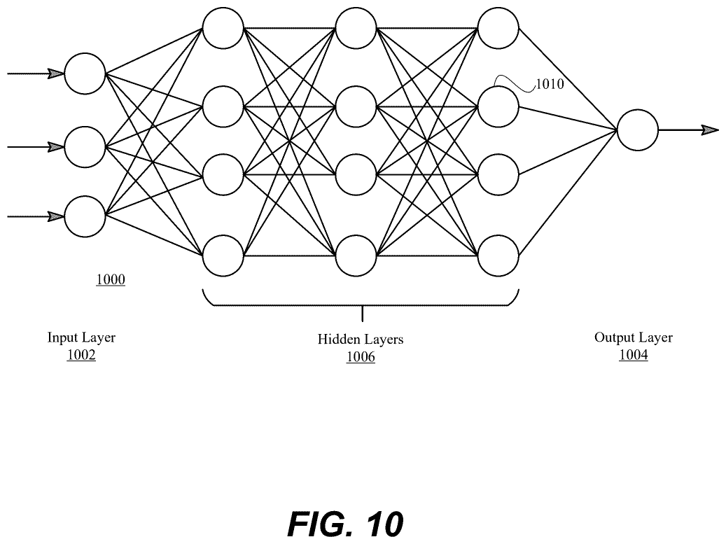

Referring to FIG. 10, a structure of an example neural network is illustrated, in accordance with some embodiments. The neural network 1000 may receive an input and generate an output. The input may be the feature vector of a training sample in the training process and the feature vector of an actual case when the neural network is making an inference. The output may be the prediction, classification, or another determination performed by the neural network. The neural network 1000 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 1000 may vary in different embodiments. In various embodiments, a neural network 1000 includes one or more layers 1002, 1004, and 1006, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 1010, kernels and/or coefficients. Training of a neural network, such as the NN 1000, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes 1010. For example, a computing device may receive a training set that includes historical user interactions with various map panels and data entry panels. Each training sample in the training set may be assigned with labels indicating actions taken by the users. The computing device, in a forward propagation, may use the machine learning model to generate predicted the data entries to be selected and the associated interactions by users. The computing device may compare the predicted outcomes with the labels of the training sample. The computing device may adjust, in a backpropagation, the weights of the machine learning model based on the comparison. The computing device backpropagates one or more error terms obtained from one or more loss functions to update a set of parameters of the machine learning model. The backpropagating may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing inference tasks or another suitable task for which the model is trained. The trained machine learning model that is trained to perform inference tasks may be trained to determine the type of data entry, opening hours and wait time of the data entry, and updates in real-time of geographical locations of the user mobile device.

In various embodiments, the training samples described above may be refined and continue to re-train the model, which the model's ability to perform the inference tasks. In some embodiments, this training and re-training processes may repeat, which results in a computer system that continues to improve its functionality through the use-retraining cycle. For example, after the model is trained, multiple rounds of re-training may be performed. The process may include periodically retraining the machine learning model. The periodic retraining may include obtaining an additional set of training data, such as through other sources, by usage of users, and by using the trained machine learning model to generate additional samples. The additional set of training data and later retraining may be based on updated data describing updated parameters in training samples. The process may also include applying the additional set of training data to the machine learning model and adjusting parameters of the machine learning model based on the applying of the additional set of training data to the machine learning model. The additional set of training data may include any features and/or characteristics that are mentioned above.

### Computing Machine Architecture

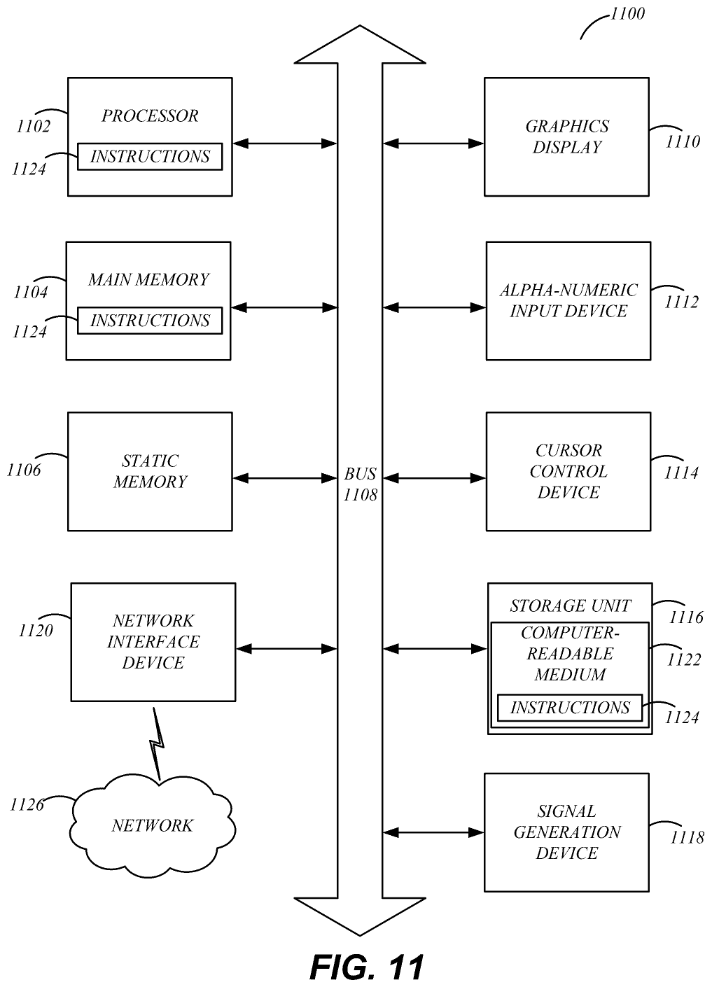

FIG. 11 is a block diagram illustrating components of an example computing machine that is capable of reading instructions from a computer-readable medium and execute them in a processor (or controller). A computer described herein may include a single computing machine shown in FIG. 11, a virtual machine, a distributed computing system that includes multiples nodes of computing machines shown in FIG. 11, or any other suitable arrangement of computing devices.

By way of example, FIG. 11 shows a diagrammatic representation of a computing machine in the example form of a computer system 1100 within which instructions 1124 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 11 may correspond to any software, hardware, or combined components shown in FIGS. 1 and 2, including but not limited to the computing server 110, the user device 120 and various engines, interfaces, terminals, and machines shown in FIG. 2. While FIG. 11 shows various hardware and software elements, each of the components described in FIG. 1 or FIG. 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1124 that specify actions to be taken by that machine. Further, while only a single machine is illustrated, the term “machine” and “computer” may also be taken to include any collection of machines that individually or jointly execute instructions 1124 to perform any one or more of the methodologies discussed herein.

The example computer system 1100 includes one or more processors 1102 such as a CPU (central processing unit), a GPU (graphics processing unit), a TPU (tensor processing unit), a DSP (digital signal processor), a system on a chip (SOC), a controller, a state machine, an application-specific integrated circuit (ASIC), a field-programmable gate array (FPGA), or any combination of these. Parts of the computing system 1100 may also include a memory 1104 that store computer code including instructions 1124 that may cause the processors 1102 to perform certain actions when the instructions are executed, directly or indirectly by the processors 1102. Instructions can be any directions, commands, or orders that may be stored in different forms, such as equipment-readable instructions, programming instructions including source code, and other communication signals and orders. Instructions may be used in a general sense and are not limited to machine-readable codes.

One and more methods described herein improve the operation speed of the processors 1102 and reduces the space required for the memory 1104. For example, the machine learning methods described herein reduces the complexity of the computation of the processors 1102 by applying one or more novel techniques that simplify the steps in training, reaching convergence, and generating results of the processors 1102. The algorithms described herein also reduces the size of the models and datasets to reduce the storage space requirement for memory 1104.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 1100 may include a main memory 1104, and a static memory 1106, which are configured to communicate with each other via a bus 1108. The computer system 1100 may further include a graphics display unit 1110 (e.g., a plasma display panel (PDP), a liquid crystal display (LCD), a projector, or a cathode ray tube (CRT)). The graphics display unit 1110, controlled by the processors 1102, displays a graphical user interface (GUI) to display one or more results and data generated by the processes described herein. The computer system 1100 may also include an alphanumeric input device 1112 (e.g., a keyboard), a cursor control device 1114 (e.g., a mouse, a trackball, a joystick, a motion sensor, or another pointing instrument), a storage unit 1116 (a hard drive, a solid state drive, a hybrid drive, a memory disk, etc.), a signal generation device 1118 (e.g., a speaker), and a network interface device 1120, which also are configured to communicate via the bus 1108.

The storage unit 1116 includes a computer-readable medium 1122 on which is stored instructions 1124 embodying any one or more of the methodologies or functions described herein. The instructions 1124 may also reside, completely or at least partially, within the main memory 1104 or within the processor 1102 (e.g., within a processor's cache memory) during execution thereof by the computer system 1100, the main memory 1104 and the processor 1102 also constituting computer-readable media. The instructions 1124 may be transmitted or received over a network 1126 via the network interface device 1120.

While computer-readable medium 1122 is shown in an example embodiment to be a single medium, the term “computer-readable medium” should be taken to include a single medium or multiple media (e.g., a centralized or distributed database, or associated caches and servers) able to store instructions (e.g., instructions 1124). The computer-readable medium may include any medium that is capable of storing instructions (e.g., instructions 1124) for execution by the processors (e.g., processors 1102) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, or storage medium, as well. The dependencies or references in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method, comprising:
causing to display, by a computing server at a client device, a graphical user interface that comprises a map panel and a data entry panel, the map panel comprises a multi-layer map, wherein the multi-layer map comprises a base layer corresponding to a tile map retrieved from a third-party map data provider and additional layers that overlay data from the computer server to the base layer;
receiving a user input interacting with the graphical user interface;
determining, based on the user input, a view area of the base layer, the view area corresponding to a geographical area and a zoom level on the base layer;
determining, based on the view area, coordinate clusters that fall within the view area, the coordinate clusters representing a predetermined set of locations that are to be highlighted in the map panel;
causing the coordinate clusters to be displayed as line features at a second layer of the multi-layer map;
receiving, from the user device, a toggle selection of two or more metadata tags comprising a first metadata tag and a second metadata tag;
causing to display, at a third layer of the multi-layer map, a first set of data entry nodes whose corresponding data entries are assigned with the first metadata tag and a second set of data entry nodes whose corresponding data entries are assigned with the second metadata tag, wherein the display of the two sets of data entry nodes is togglable;
determining, based on the view area, a third set of data entries that are assigned with a third metadata tag; and
causing to display, at the data entry panel of the graphical user interface, a list view of the third set of data entries, wherein a data entry node in the third set is displayable at the map panel while the first and second sets of data entry nodes continue to display at the map panel.

2. The computer-implemented method of claim 1, wherein the data retrieved from the third-party map data provider includes geospatial data, satellite imagery, street maps, data about specific points of interest, demographic data, and real-time data.

3. The computer-implemented method of claim 1, wherein the metadata tag is a label to describe various attributes of properties of a specific point of interest.

4. The computer-implemented method of claim 3, wherein the metadata tag labels a point of interest for hotels, shops, attractions, pre-determined streets, luxurious points of interest, ease of commutability, or access to public-transportation.

5. The computer-implemented method of claim 1, wherein determining the predetermined set of locations includes:
extracting a set of locations of interest from third-party databases of travel aggregators and booking sites, social media platforms, tourism guides and magazines; and
verifying a set of locations of interest from map and navigation databases.

6. The computer-implemented method of claim 1, wherein the togglable set of data entries allows users to switch between different sets of data inputs within a single interface.

7. The computer-implemented method of claim 1, wherein the zoom level on the base layer is adjustable by an icon interface.

8. The computer-implemented method of claim 1, wherein the coordinate cluster is in persistent view of the multi-layer map interface, independent of the zoom level, the data entries, or filters.

9. The computer-implemented method of claim 8, wherein the coordinate cluster in persistent view of the multi-layer map interface provides a clear visual explanation of sites of interest relative to the coordinate cluster.

10. A system, comprising:
one or more processors; and
memory for storing computing code comprising instructions, the instructions, when executed by the one or more processors, cause the one or more processors to perform steps comprising:
causing to display, by a computing server at a client device, a graphical user interface that comprises a map panel and a data entry panel, the map panel comprises a multi-layer map, wherein the multi-layer map comprises a base layer corresponding to a tile map retrieved from a third-party map data provider and additional layers that overlay data from the computer server to the base layer;
receiving a user input interacting with the graphical user interface;
determining, based on the user input, a view area of the base layer, the view area corresponding to a geographical area and a zoom level on the base layer;
determining, based on the view area, coordinate clusters that fall within the view area, the coordinate clusters representing a predetermined set of locations that are to be highlighted in the map panel;
causing the coordinate clusters to be displayed as line features at a second layer of the multi-layer map;
receiving, from the user device, a toggle selection of two or more metadata tags comprising a first metadata tag and a second metadata tag;
causing to display, at a third layer of the multi-layer map, a first set of data entry nodes whose corresponding data entries are assigned with the first metadata tag and a second set of data entry nodes whose corresponding data entries are assigned with the second metadata tag, wherein the display of the two sets of data entry nodes is togglable;
determining, based on the view area, a third set of data entries that are assigned with a third metadata tag; and
causing to display, at the data entry panel of the graphical user interface, a list view of the third set of data entries, wherein a data entry node in the third set is displayable at the map panel while the first and second sets of data entry nodes continue to display at the map panel.

11. The system of claim 10, wherein the data retrieved from the third-party map data provider includes geospatial data, satellite imagery, street maps, data about specific points of interest, demographic data, and real-time data.

12. The system of claim 10, wherein the metadata tag is a label to describe various attributes of properties of a specific point of interest.

13. The system of claim 12, wherein the metadata tag labels a point of interest for hotels, shops, attractions, pre-determined streets, luxurious points of interest, ease of commutability, or access to public-transportation.

14. The system of claim 10, wherein determining the predetermined set of locations includes:
extracting a set of locations of interest from third-party databases of travel aggregators and booking sites, social media platforms, tourism guides and magazines; and
verifying a set of locations of interest from map and navigation databases.

15. The system of claim 10, wherein the togglable set of data entries allows users to switch between different sets of data inputs within a single interface.

16. The system of claim 10, wherein the zoom level on the base layer is adjustable by an icon interface.

17. The system of claim 10, wherein the coordinate cluster is in persistent view of the multi-layer map interface, independent of the zoom level, the data entries, or filters.

18. The system of claim 16, wherein the coordinate cluster in persistent view of the multi-layer map interface provides a clear visual explanation of sites of interest relative to the coordinate cluster.

19. A non-transitory computer readable medium for storing computing code comprising instructions, the instructions, when executed by one or more processors, cause the one or more processors to perform steps comprising:
causing to display, by a computing server at a client device, a graphical user interface that comprises a map panel and a data entry panel, the map panel comprises a multi-layer map, wherein the multi-layer map comprises a base layer corresponding to a tile map retrieved from a third-party map data provider and additional layers that overlay data from the computer server to the base layer;
receiving a user input interacting with the graphical user interface;
determining, based on the user input, a view area of the base layer, the view area corresponding to a geographical area and a zoom level on the base layer;
determining, based on the view area, coordinate clusters that fall within the view area, the coordinate clusters representing a predetermined set of locations that are to be highlighted in the map panel;
causing the coordinate clusters to be displayed as line features at a second layer of the multi-layer map;
receiving, from the user device, a toggle selection of two or more metadata tags comprising a first metadata tag and a second metadata tag;
causing to display, at a third layer of the multi-layer map, a first set of data entry nodes whose corresponding data entries are assigned with the first metadata tag and a second set of data entry nodes whose corresponding data entries are assigned with the second metadata tag, wherein the display of the two sets of data entry nodes is togglable;
determining, based on the view area, a third set of data entries that are assigned with a third metadata tag; and
causing to display, at the data entry panel of the graphical user interface, a list view of the third set of data entries, wherein a data entry node in the third set is displayable at the map panel while the first and second sets of data entry nodes continue to display at the map panel.

20. The non-transitory computer readable medium of claim 19, wherein the data retrieved from the third-party map data provider includes geospatial data, satellite imagery, street maps, data about specific points of interest, demographic data, and real-time data.
